(19) United States
(12) Patent Application Publication
(10) Pub. No.: US 2026/0074850 A1
(43) Pub. Date: Mar. 12, 2026

(54) COMMUNICATION METHOD AND COMMUNICATION APPARATUS

(71) Applicant: HUAWEI TECHNOLOGIES CO., LTD., Shenzhen (CN)

(72) Inventors: Feiran Zhao, Hangzhou (CN); Ying Chen, Hangzhou (CN)

(21) Appl. No.: 19/392,365

(22) Filed: Nov. 18, 2025

Related U.S. Application Data
(63) Continuation of application No. PCT/CN2024/089643, filed on Apr. 24, 2024.

(30) Foreign Application Priority Data
May 19, 2023 (CN) 202310572824.5

(51) Int. Cl. H04L 5/00; H04L 1/00

(52) U.S. Cl. CPC H04L 5/0044; H04L 1/0003

(57) ABSTRACT

This application provides a communication method and a communication apparatus. In the method, a number of repetitions for a PUCCH is configured for a terminal device, so that the terminal device can repeatedly send uplink information through the PUCCH. This helps ensure successful sending of the uplink information, thereby improving communication quality of the terminal device. In addition, the number of repetitions for the PUCCH may be dynamically adjusted, so that an appropriate number of repetitions can be configured for the terminal device. This helps reduce power consumption of the terminal device.

### CROSS-REFERENCE TO RELATED APPLICATIONS

This application is a continuation of International Application No. PCT/CN2024/089643, filed on April 24, 2024, which claims priority to Chinese Patent Application No. 202310572824.5, filed on May 19, 2023. The disclosures of the aforementioned applications are hereby incorporated by reference in their entireties.

### TECHNICAL FIELD

This application relates to the field of communication technologies, and in particular, to a communication method and a communication apparatus.

### BACKGROUND

With development of communication technologies, users have increasingly higher requirements for communication quality. Therefore, in some communication scenarios, if communication quality deteriorates, a corresponding measurement needs to be taken to improve communication quality.

During uplink communication of a terminal device, communication quality may be poor. For example, in a satellite communication scenario, because a non-terrestrial network (non-terrestrial network, NTN) channel between the terminal device and a satellite is blocked by a building, an elevated road, or clouds, the terminal device is located at an edge of a satellite cell, or the like, quality of the channel between the terminal device and the satellite may be poor.

How to improve communication quality of the terminal device needs to be resolved.

### SUMMARY

Embodiments of this application provide a communication method and a communication apparatus, to improve communication quality of a terminal device.

According to a first aspect, an embodiment of this application provides a communication method. The method may be performed by a terminal device or a module (for example, a chip) used in the terminal device. The method includes: receiving first downlink control information (downlink control information, DCI); determining a first number of repetitions for a physical uplink control channel (physical uplink control channel, PUCCH) based on the first DCI; receiving indication information; and determining a second number of repetitions for the PUCCH based on the indication information.

In the foregoing solution, a number of repetitions for the PUCCH is configured for the terminal device, so that the terminal device can repeatedly send uplink information through the PUCCH. This helps ensure successful sending of the uplink information, thereby improving communication quality of the terminal device. In addition, the number of repetitions for the PUCCH may be dynamically adjusted, so that an appropriate number of repetitions for the PUCCH can be configured for the terminal device. This helps reduce power consumption of the terminal device.

In a possible implementation method, the method further includes: receiving a message 4 (message 4, MSG4) based on the first DCI, where the PUCCH carries response information corresponding to the MSG4.

In the foregoing solution, the PUCCH that carries the response information corresponding to the MSG4 is enhanced, that is, the uplink information is allowed to be repeatedly sent on the PUCCH. This helps ensure successful sending of the response information, and further helps ensure a probability of successful random access of the terminal device.

In a possible implementation method, the indication information includes information about a changed bandwidth part (bandwidth part, BWP). The determining the second number of repetitions for the PUCCH based on the indication information includes: determining a difference between the changed BWP and an initial BWP based on the information about the changed BWP; determining a change amount of a number of repetitions based on the difference; and determining the second number of repetitions based on the change amount of the number of repetitions and the first number of repetitions.

In the foregoing solution, the second number of repetitions is implicitly indicated by the information about the changed BWP, so that an existing protocol is slightly modified, and compatibility with an existing standard is high.

In a possible implementation method, the determining the change amount of the number of repetitions based on the difference includes: determining the change amount of the number of repetitions based on the difference between the changed BWP and the initial BWP and a step of the number of repetitions.

In a possible implementation method, the step of the number of repetitions is predefined. Alternatively, the method further includes: receiving system information, where the system information includes the step of the number of repetitions.

In a possible implementation method, when the difference is greater than 0, the second number of repetitions is less than the first number of repetitions. Alternatively, when the difference is less than 0, the second number of repetitions is greater than the first number of repetitions.

In a possible implementation method, the indication information includes a changed BWP. The determining the second number of repetitions for the PUCCH based on the indication information includes: determining the second number of repetitions corresponding to the changed BWP.

In the foregoing solution, the second number of repetitions is explicitly indicated by the information about the changed BWP, so that an existing protocol is slightly modified, and compatibility with an existing standard is high.

In a possible implementation method, the indication information is any one of the following: second DCI, a radio resource control (radio resource control, RRC) message, or a medium access control control element (medium access control control element, MAC CE).

In a possible implementation method, the indication information is a first field in third DCI, a first part of bits in the first field indicate a modulation and coding scheme (modulation and coding scheme, MCS), and a second part of bits in the first field indicate the second number of repetitions.

In the foregoing solution, the second number of repetitions is explicitly indicated by the field in the third DCI. This helps the terminal device accurately determine the second number of repetitions.

In a possible implementation method, the indication information is a second field in fourth DCI, and the second field indicates the PUCCH and indicates the second number of repetitions.

In the foregoing solution, the second number of repetitions is explicitly indicated by the field in the fourth DCI. This helps the terminal device accurately determine the second number of repetitions. In addition, an existing meaning of the field is not affected, the protocol is slightly modified, and compatibility with the existing standard is high.

In a possible implementation method, the indication information includes M bits in a third field in fifth DCI and N bits in a fourth field in the fifth DCI, the M bits and the N bits jointly indicate the second number of repetitions, and both M and N are positive integers.

In the foregoing solution, a plurality of fields in the fifth DCI jointly indicate the second number of repetitions, so that the fields in the fifth DCI are slightly affected, and a larger number of repetitions can be indicated.

In a possible implementation method, before the receiving the indication information, the method further includes: sending capability information, where the capability information indicates that the terminal device supports dynamic adjustment of a number of repetitions.

In the foregoing solution, the terminal device reports a capability of the terminal device. This helps a network device accurately determine whether to update the number of repetitions for the PUCCH.

According to a second aspect, an embodiment of this application provides a communication method. The method may be performed by a network device or a module (for example, a chip) used in the network device. The method includes: sending first DCI, where the first DCI is used to determine a first number of repetitions for a PUCCH; and sending indication information, where the indication information is used to determine a second number of repetitions for the PUCCH, and the second number of repetitions is different from the first number of repetitions.

In the foregoing solution, a number of repetitions for the PUCCH is configured for the terminal device, so that the terminal device can repeatedly send uplink information through the PUCCH. This helps ensure successful sending of the uplink information, thereby improving communication quality of the terminal device. In addition, the number of repetitions for the PUCCH may be dynamically adjusted, so that an appropriate number of repetitions for the PUCCH can be configured for the terminal device. This helps reduce power consumption of the terminal device.

In a possible implementation method, the first DCI is further used to receive an MSG4, and the PUCCH carries response information corresponding to the MSG4.

In the foregoing solution, the PUCCH that carries the response information corresponding to the MSG4 is enhanced, that is, the uplink information is allowed to be repeatedly sent on the PUCCH. This helps ensure successful sending of the response information, and further helps ensure a probability of successful random access of the terminal device.

In a possible implementation method, the indication information includes information about a changed BWP, and the information about the changed BWP is used to determine the second number of repetitions.

In a possible implementation method, that the information about the changed BWP is used to determine the second number of repetitions includes: The information about the changed BWP and a step of a number of repetitions are used to determine the second number of repetitions.

In the foregoing solution, the second number of repetitions is implicitly indicated by the information about the changed BWP, so that an existing protocol is slightly modified, and compatibility with an existing standard is high.

In a possible implementation method, the step of the number of repetitions is predefined. Alternatively, the method further includes: sending system information, where the system information includes the step of the number of repetitions.

In a possible implementation method, when a difference is greater than 0, the second number of repetitions is less than the first number of repetitions. Alternatively, when a difference is less than 0, the second number of repetitions is greater than the first number of repetitions.

In a possible implementation method, the indication information is second DCI, RRC signaling, or a MAC CE.

In a possible implementation method, the indication information is a first field in third DCI, a first part of bits in the first field indicate an MCS, and a second part of bits in the first field indicate the second number of repetitions.

In the foregoing solution, the second number of repetitions is explicitly indicated by the field in the third DCI. This helps the terminal device accurately determine the second number of repetitions.

In a possible implementation method, the indication information is a second field in fourth DCI, and the second field indicates the PUCCH and indicates the second number of repetitions.

In the foregoing solution, the second number of repetitions is explicitly indicated by the field in the fourth DCI. This helps the terminal device accurately determine the second number of repetitions. In addition, an existing meaning of the field is not affected, the protocol is slightly modified, and compatibility with the existing standard is high.

In a possible implementation method, the indication information includes M bits in a third field in fifth DCI and N bits in a fourth field in the fifth DCI, the M bits and the N bits jointly indicate the second number of repetitions, and both M and N are positive integers.

In the foregoing solution, a plurality of fields in the fifth DCI jointly indicate the second number of repetitions, so that the fields in the fifth DCI are slightly affected, and a larger number of repetitions can be indicated.

In a possible implementation method, before the sending the indication information, the method further includes: receiving capability information, where the capability information indicates that the terminal device supports dynamic adjustment of a number of repetitions.

In the foregoing solution, the terminal device reports a capability of the terminal device. This helps the network device accurately determine whether to update the number of repetitions for the PUCCH.

According to a third aspect, an embodiment of this application provides a communication apparatus. The apparatus may be a terminal device, or may be a module (for example, a chip) used in the terminal device. The apparatus has a function of implementing any one of the implementation methods of the first aspect. The function may be implemented by hardware, or may be implemented by hardware executing corresponding software. The hardware or the software includes one or more modules corresponding to the function.

According to a fourth aspect, an embodiment of this application provides a communication apparatus. The apparatus may be a network device, or may be a module (for example, a chip) used in the network device. The apparatus has a function of implementing any one of the implementation methods of the second aspect. The function may be implemented by hardware, or may be implemented by hardware executing corresponding software. The hardware or the software includes one or more modules corresponding to the function.

According to a fifth aspect, an embodiment of this application provides a communication apparatus, including a unit or means (means) used to perform steps of any one of the implementation methods of the first aspect and the second aspect.

According to a sixth aspect, an embodiment of this application provides a communication apparatus, including a processor and an interface circuit. The processor is configured to: communicate with another apparatus through the interface circuit, and perform any one of the implementation methods of the first aspect and the second aspect. There are one or more processors.

According to a seventh aspect, an embodiment of this application provides a communication apparatus, including a processor coupled to a memory. The processor is configured to invoke a program stored in the memory, to perform any one of the implementation methods of the first aspect and the second aspect. The memory may be located inside or outside the apparatus. In addition, there may be one or more processors.

According to an eighth aspect, an embodiment of this application provides a communication apparatus, including a processor and a memory. The memory is configured to store computer instructions, and when the apparatus is run, the processor executes the computer instructions stored in the memory, to enable the apparatus to perform any one of the implementation methods of the first aspect and the second aspect.

According to a ninth aspect, an embodiment of this application further provides a computer program product. The computer program product includes a computer program or instructions. When the computer program or the instructions are run by a communication apparatus, any one of the implementation methods of the first aspect and the second aspect is performed.

According to a tenth aspect, an embodiment of this application further provides a computer-readable storage medium. The computer-readable storage medium stores instructions, and when the instructions are run on a communication apparatus, any one of the implementation methods of the first aspect and the second aspect is performed.

According to an eleventh aspect, an embodiment of this application further provides a chip system, including a processor, configured to perform any one of the implementation methods of the first aspect and the second aspect.

According to a twelfth aspect, an embodiment of this application further provides a communication method. The method includes: A network device sends first DCI. A terminal device determines a first number of repetitions for a PUCCH based on the first DCI. The network device sends indication information. The terminal device determines a second number of repetitions for the PUCCH based on the indication information, where the second number of repetitions is different from the first number of repetitions.

### BRIEF DESCRIPTION OF DRAWINGS

FIG. 1(a) is a diagram of an architecture of a communication system to which an embodiment of this application is applied;

FIG. 1(b) is a diagram of a network device;

FIG. 2 is a schematic flowchart of a communication method according to an embodiment of this application;

FIG. 3 is a diagram of a structure of a communication apparatus according to an embodiment of this application; and

FIG. 4 is a diagram of a structure of a communication apparatus according to an embodiment of this application.

### DESCRIPTION OF EMBODIMENTS

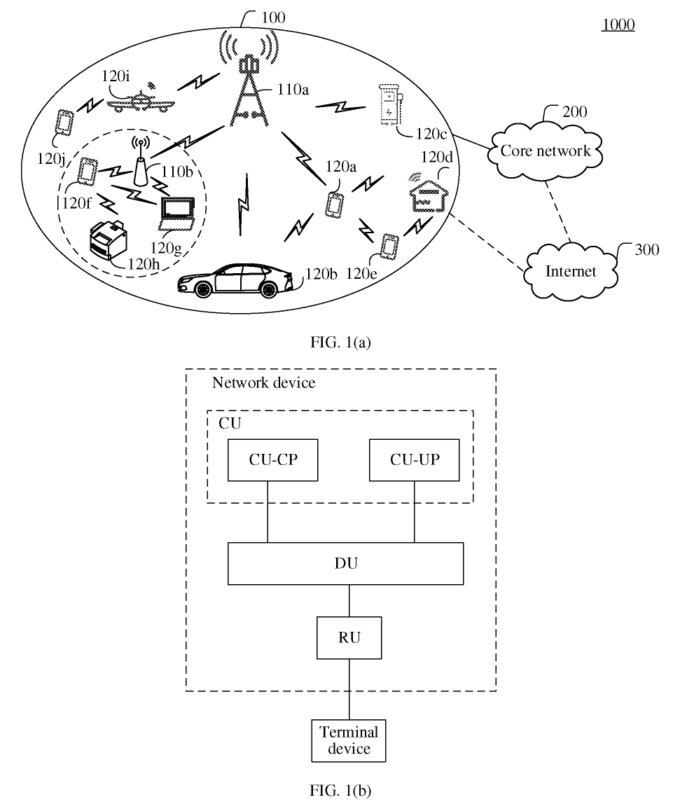

FIG. 1(a) is a diagram of an architecture of a communication system to which an embodiment of this application is applied. A communication system 1000 shown in FIG. 1(a) includes a radio access network 100 and a core network 200. Optionally, the communication system 1000 further includes the Internet 300. The radio access network 100 may include at least one network device (for example, 110a and 110b shown in FIG. 1(a)), and may further include at least one terminal device (for example, 120a to 120j shown in FIG. 1(a)). The terminal device is connected to the network device in a wireless manner, and the network device is connected to the core network in a wireless manner or wired manner. A core network device and the network device may be different physical devices that are independent of each other, or a function of a core network device and a logical function of the network device may be integrated into a same physical device, or some functions of the core network device and some functions of the network device may be integrated into one physical device. Terminal devices may be connected to each other in a wired or wireless manner, and network devices may be connected to each other in a wired or wireless manner. FIG. 1(a) is merely a diagram. The communication system may further include another network device, for example, may further include a wireless relay device and a wireless backhaul device, which are not shown in FIG. 1(a).

The network device is an access device through which the terminal device accesses the communication system in a wired or wireless manner. The network device may be a base station (base station), an evolved NodeB (evolved NodeB, eNodeB), a transmission reception point (transmission reception point, TRP), a next generation NodeB (next generation NodeB, gNB) in a 5th generation (5th generation, 5G) mobile communication system, a next generation NodeB in a 6th generation (6th generation, 6G) mobile communication system, a base station in a future mobile communication system, or an access node in a wireless fidelity (wireless fidelity, Wi-Fi) system; or may be a module or a unit that completes some functions of the base station, for example, may be a central unit (central unit, CU), or may be a distributed unit (distributed unit, DU). The CU herein completes functions of a radio resource control protocol and a packet data convergence protocol (packet data convergence protocol, PDCP) of the base station, and may further complete a function of a service data adaptation protocol (service data adaptation protocol, SDAP). The DU completes functions of a radio link control layer and a medium access control (medium access control, MAC) layer of the base station, and may further complete some or all functions of a physical layer. For specific descriptions of the foregoing protocol layers, refer to technical specifications related to the 3rd generation partnership project (3rd generation partnership project, 3GPP). The network device may be a macro base station (for example, 110a shown in FIG. 1(a)), may be an uncrewed aerial vehicle, a micro base station or an indoor base station (for example, 110b shown in FIG. 1(a)), or may be a relay node, a donor node, or the like. A specific technology and a specific device form that are used by the network device are not limited in embodiments of this application.

The terminal device is a device that has a wireless transceiver function, and may send a signal to the network device, or receive a signal from the network device. The terminal device includes but is not limited to a terminal apparatus, a terminal, user equipment (user equipment, UE), a mobile station, a mobile terminal, and the like. The terminal device may be widely used in various scenarios, for example, device-to-device (device-to-device, D2D), vehicle-to-everything (vehicle-to-everything, V2X) communication, machine-type communication (machine-type communication, MTC), an internet of things (internet of things, IOT), virtual reality, augmented reality, industrial control, self-driving, telemedicine, a smart grid, smart furniture, a smart office, a smart wearable, smart transportation, and a smart city. The terminal device may specifically be a mobile phone, a tablet computer, a computer with a wireless transceiver function, a wearable device, a vehicle, an uncrewed aerial vehicle, an airplane, a ship, a robot, a mechanical arm, a smart home device, or the like. A specific technology and a specific device form that are used by the terminal device are not limited in embodiments of this application.

The network device and the terminal device may be at fixed locations or may be movable. The network device and the terminal device may be deployed on the land, including an indoor device, an outdoor device, a handheld device, or a vehicle-mounted device; may be deployed on a water surface; or may be deployed on an airplane, a balloon, and an artificial satellite. Application scenarios of the network device and the terminal device are not limited in embodiments of this application.

A role of the network device and a role of the terminal device may be relative to each other. For example, a helicopter or an uncrewed aerial vehicle 120i in FIG. 1(a) may be configured as a mobile network device. For those terminal devices 120j that access the radio access network 100 through 120i, the terminal device 120i is a network device. However, for the network device 110a, 120i is a terminal device, that is, 110a and 120i communicate with each other according to a wireless air interface protocol. Certainly, 110a and 120i may alternatively communicate with each other according to an interface protocol between network devices. In this case, for 110a, 120i is also a network device. Therefore, the network device and the terminal device may be collectively referred to as communication apparatuses. 110a and 110b in FIG. 1(a) may be referred to as communication apparatuses functioning as the network device, and 120a to 120j in FIG. 1(a) may be referred to as communication apparatuses functioning as the terminal device.

Communication between the network device and the terminal device, communication between the network devices, and communication between the terminal devices may be performed by using a licensed spectrum, an unlicensed spectrum, or both a licensed spectrum and an unlicensed spectrum; or may be performed by using a spectrum below 6 gigahertz (gigahertz, GHz), a spectrum above 6 GHz, or both a spectrum below 6 GHz and a spectrum above 6 GHz. A spectrum resource used for wireless communication is not limited in embodiments of this application.

In embodiments of this application, a function of the network device may alternatively be performed by a module (for example, a chip) in the network device, or may be performed by a control subsystem including the function of the network device. The control subsystem including the function of the network device herein may be a control center in the foregoing application scenarios such as the smart grid, the industrial control, the intelligent transportation, and the smart city. A function of the terminal device may alternatively be performed by a module (for example, a chip or a modem) in the terminal device, or may be performed by an apparatus including the function of the terminal device.

In this application, the network device sends a downlink signal or downlink information to the terminal device, and the downlink information is carried on a downlink channel. The terminal device sends an uplink signal or uplink information to the network device, and the uplink information is carried on an uplink channel. To communicate with the network device, the terminal device needs to establish a wireless connection to a cell controlled by the network device. The cell to which the terminal device establishes the wireless connection is referred to as a serving cell of the terminal device.

FIG. 1(b) is a diagram of a network device. As shown in FIG. 1(b), the access network device includes one or more CUs, one or more DUs, and one or more radio units (radio units, RUs). For clarity, FIG. 1(b) shows only one CU, one DU, and one RU. The CU is configured to connect to a core network and the one or more DUs. Optionally, the CU may have some functions of the core network. The CU may include a CU-control plane (control plane, CP) and a CU-user plane (user plane, UP).

The CU and the DU may be configured based on protocol layer functions implemented by the CU and the DU in a wireless network. For example, the CU is configured to implement functions of a PDCP layer and a protocol layer (for example, a radio resource control (radio resource control, RRC) layer and/or an SDAP layer) above the PDCP layer. The DU is configured to implement a function of a protocol layer (for example, a radio link control (radio link control, RLC) layer, a MAC layer, and/or a physical (physical, PHY) layer) below the PDCP layer. For another example, the CU is configured to implement a function of a protocol layer (for example, an RRC layer and/or an SDAP layer) above a PDCP layer. The DU is configured to implement functions of the PDCP layer and a protocol layer (for example, an RLC layer, a MAC layer, and/or a PHY layer) below the PDCP layer.

The foregoing configuration of the CU and the DU is merely an example. Alternatively, functions of the CU and the DU may be configured based on a need. For example, the CU or the DU may be configured to have functions of more protocol layers, or the CU or the DU may be configured to have some processing functions of a protocol layer. For example, some functions of the RLC layer and a function of a protocol layer above the RLC layer are set in the CU, and a remaining function of the RLC layer and a function of a protocol layer below the RLC layer are set in the DU. For another example, division of functions of the CU or the DU may be performed based on a service type or another system requirement, for example, based on a latency. A function whose processing time needs to meet a requirement of a low latency is set in the DU, and a function whose processing time does not need to meet the latency requirement is set in the CU.

The DU and the RU may work together to jointly implement a function of the PHY layer. One DU may be connected to the one or more RUs. Functions of the DU and the RU may be configured in a plurality of manners based on a design. For example, the DU is configured to implement a baseband function, and the RU is configured to implement an intermediate radio frequency function. For another example, the DU is configured to implement a higher-layer function of the PHY layer, and the RU is configured to implement a lower-layer function of the PHY layer, or implement the lower-layer function and a radio frequency function. The higher-layer function of the physical layer may include some functions of the physical layer, and these functions are closer to the MAC layer. The lower-layer function of the physical layer may include other functions of the physical layer, and these functions are closer to an intermediate radio frequency side.

PUCCH resources are classified into a cell-level common (common) PUCCH resource configuration and a terminal device‒level dedicated (dedicated) PUCCH resource configuration.

1. Cell-level common PUCCH resource configuration

The cell-level common PUCCH resource configuration may also be referred to as a common PUCCH resource configuration for short.

The common PUCCH resource configuration is mainly used in an initial access phase. Before an RRC (re)configuration takes effect, the terminal device cannot obtain the terminal device‒level dedicated PUCCH resource configuration. When the terminal device is not configured with a dedicated PUCCH resource, the terminal device needs to use a common PUCCH resource to perform uplink transmission.

For specific descriptions of the common PUCCH resource configuration, refer to TS 38.213. The common PUCCH resource configuration is configured by using a field pucch-ConfigCommon in a high-layer parameter BWP-UplinkCommon, and a group of common PUCCH resources are determined for a terminal device in a cell by using both a system information block 1 (system information block 1, SIB1) and a PUCCH resource indicator (PUCCH resource indicator, PRI) field in DCI.

Currently, the common PUCCH resource configuration does not include configurations of parameters such as a number of repetitions and inter-slot frequency hopping. In other words, the terminal device can use the common PUCCH resource only once to perform PUCCH uplink transmission, and inter-slot frequency hopping is not supported.

2. Terminal device‒level dedicated PUCCH resource configuration

The terminal device‒level dedicated PUCCH resource configuration is also referred to as a UE-level dedicated PUCCH resource configuration, a user equipment‒level dedicated PUCCH resource configuration, or the like, or may also be referred to as a dedicated PUCCH resource configuration for short.

After a terminal device enters an RRC connected state and the RRC takes effect, or after the terminal device is authenticated by a core network, a dedicated PUCCH resource may be configured for the terminal device.

The dedicated PUCCH resource configuration is separately configured for each terminal device by using a parameter pucch-Config in BWP-UplinkDedicated. The dedicated PUCCH resource configuration may carry a number of repetitions. In other words, the terminal device is allowed to repeatedly send uplink information by using the dedicated PUCCH resource for a plurality of times when transmitting the uplink PUCCH, to meet a requirement of reducing a decoding threshold.

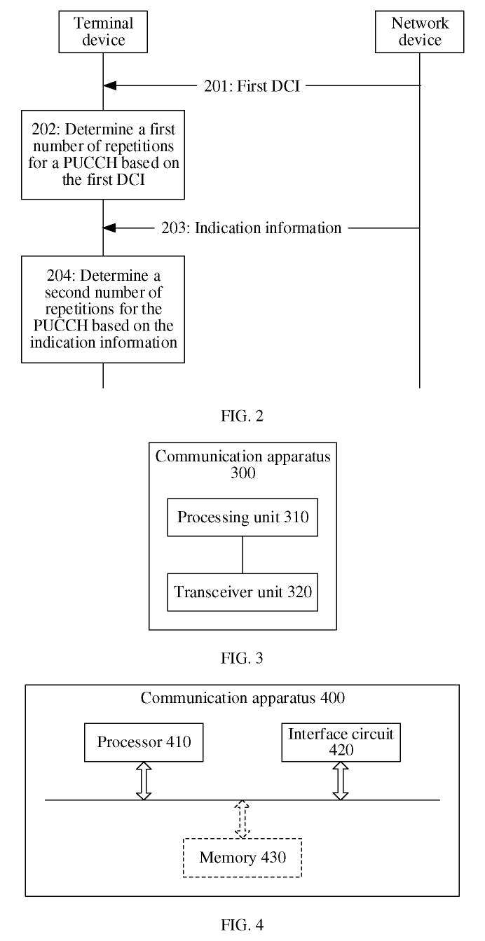

FIG. 2 is a schematic flowchart of a communication method according to an embodiment of this application. The method is performed by a terminal device or a module used in a terminal device, and a network device or a module used in the network device. The following uses an example in which the terminal device and the network device perform the method.

The method includes the following steps.

Step 201: The network device sends first DCI to the terminal device. Correspondingly, the terminal device receives the first DCI.

Step 202: The terminal device determines a first number of repetitions for a PUCCH based on the first DCI.

The PUCCH is a cell-level PUCCH or a common PUCCH.

For example, the first DCI includes a cell-level common PUCCH resource configuration, and the cell-level common PUCCH resource configuration includes the first number of repetitions.

For example, the first number of repetitions is equal to 4. In this case, the terminal device may initially send uplink information by using the PUCCH resource, and may further repeatedly send the uplink information for a maximum of four times. Alternatively, the first number of repetitions may include initial sending. In this case, the terminal device may initially send uplink information by using the PUCCH resource, and may further repeatedly send the uplink information for a maximum of three times.

Information carried on the PUCCH may be uplink information of any type. For example, when the first DCI is used to schedule a physical downlink shared channel (physical downlink shared channel, PDSCH) including an MSG4, the terminal device receives the MSG4 based on the first DCI, that is, receives the MSG4 on the PDSCH indicated by the first DCI. When the terminal device determines that random access succeeds, the terminal device sends response information to the network device through the PUCCH, that is, the PUCCH carries response information corresponding to the MSG4. The response information is, for example, an acknowledgment (ACK) or a hybrid automatic repeat request (hybrid automatic repeat request, HARQ) ACK.

Step 203: The network device sends indication information to the terminal device. Correspondingly, the terminal device receives the indication information.

Step 204: The terminal device determines a second number of repetitions for the PUCCH based on the indication information.

The second number of repetitions may be the same as or different from the foregoing first number of repetitions.

It should be noted that the first number of repetitions may be a number of repetitions for first uplink information, and the second number of repetitions is a number of repetitions for second uplink information. The first uplink information and the second uplink information may be the same or may be different.

In the foregoing solution, a number of repetitions for the PUCCH is configured for the terminal device, so that the terminal device can repeatedly send uplink information through the PUCCH. This helps ensure successful sending of the uplink information, thereby improving communication quality of the terminal device. In addition, the number of repetitions for the PUCCH may be dynamically adjusted, so that an appropriate number of repetitions can be configured for the terminal device. This helps reduce power consumption of the terminal device.

In an implementation method, before step 201, the terminal device sends capability information to the network device, where the capability information indicates that the terminal device supports a dynamic number of repetitions and/or supports dynamic adjustment of a number of repetitions. If the terminal device supports the dynamic number of repetitions, the network device performs step 201 based on the capability information. If the terminal device supports dynamic adjustment of the number of repetitions, the network device performs step 203 based on the capability information. For example, the capability information may be carried in a message 3 (MSG3) and sent to the network device.

The following describes different implementation methods for the indication information.

In an implementation method 1, the indication information includes information about a changed BWP.

The information about the changed BWP may be the changed BWP, or may be a difference between the changed BWP and an initial BWP.

In a first manner, the terminal device determines the difference (referred to as a BWP difference below) between the changed BWP and the initial BWP based on the information about the changed BWP, and then determines a change amount of a number of repetitions based on the BWP difference, so as to determine the second number of repetitions based on the change amount of the number of repetitions and the first number of repetitions. For example, a correspondence between the BWP difference and the change amount of the number of repetitions may be predefined, so that after determining the BWP difference, the terminal device can determine the change amount of the number of repetitions based on the correspondence. A sum of the change amount of the number of repetitions and the first number of repetitions is the second number of repetitions. The change amount of the number of repetitions herein may be a positive number, or may be a negative number. For example, if the first number of repetitions is 3, the initial BWP is 10 megahertz (MHz), and the changed BWP is 20 MHz, the BWP difference is +10. If a corresponding change amount of a number of repetitions is –2 when the BWP difference is +10, the second number of repetitions is 1. For another example, if the first number of repetitions is 3, the initial BWP is 10 MHz, and the changed BWP is 5 MHz, the BWP difference is –5. If a corresponding change amount of a number of repetitions is +1 when the BWP difference is –5, the second number of repetitions is 4.

In a second manner, the terminal device determines a difference (referred to as a BWP difference below) between the changed BWP and the initial BWP based on the information about the changed BWP, and then determines a change amount of a number of repetitions based on the BWP difference and a step of the number of repetitions, so as to determine the second number of repetitions based on the change amount of the number of repetitions and the first number of repetitions. For example, it may be predefined that each time a BWP changes by X, the number of repetitions changes once (that is, the step of the number of repetitions is equal to 1). Therefore, the terminal device may determine the change amount of the number of repetitions, and a sum of the change amount of the number of repetitions and the first number of repetitions is the second number of repetitions. The change amount of the number of repetitions herein may be a positive number, or may be a negative number. The step of the number of repetitions is predefined, or is sent by the network device to the terminal device by using system information (for example, the SIB1). In other words, the system information includes the step of the number of repetitions. For example, if the first number of repetitions is 3, the initial BWP is 10 MHz, the changed BWP is 20 MHz, and it is predefined that each time the BWP changes by 5 MHz, the number of repetitions changes once, because the BWP difference is +10, the change amount of the number of repetitions is –2, and the second number of repetitions is 1. For another example, if the first number of repetitions is 3, the initial BWP is 10 MHz, the changed BWP is 5 MHz, and it is predefined that each time the BWP changes by 5 MHz, the number of repetitions changes once, because the BWP difference is ‒5, the change amount of the number of repetitions is +1, and the second number of repetitions is 4.

In a third manner, the indication information includes the changed BWP. In this case, the terminal device determines, based on a predefined correspondence between a BWP and a number of repetitions, the second number of repetitions corresponding to the changed BWP. For example, it is predefined that when the changed BWP is within an interval 1, a changed number of repetitions (namely, the second number of repetitions) is x1, when the changed BWP is within an interval 2, a changed number of repetitions (namely, the second number of repetitions) is x2, or the like.

In an implementation method, based on any one of the foregoing three manners, when the BWP difference is greater than 0, that is, when the changed BWP is greater than the initial BWP, the change amount of the number of repetitions is a negative number, that is, the second number of repetitions is less than the first number of repetitions. The reason is that when the BWP increases, a PUCCH frequency hopping interval increases, and a frequency hopping gain increases. Therefore, the number of repetitions can be reduced. When the BWP difference is less than 0, that is, when the changed BWP is less than the initial BWP, the change amount of the number of repetitions is a positive number, that is, the second number of repetitions is greater than the first number of repetitions. The reason is that when the BWP decreases, the PUCCH frequency hopping interval is reduced, and the frequency hopping gain is reduced. Therefore, the number of repetitions can be increased, to achieve a gain.

In an implementation method, the indication information in the foregoing three manners is any one of the following: second DCI, RRC signaling, or a MAC CE. The second DCI may be DCI format 0_1, DCI format 1_0, DCI format 1_1, DCI format 1_2, or the like. For example, a Bandwidth part indicator field in the second DCI may indicate information about a changed BWP, and the field triggers the terminal device to switch the BWP. The RRC signaling may be RRC configuration signaling, RRC reconfiguration signaling, or the like.

It should be noted that, if the network device does not perform scheduling for the terminal device, the terminal device may automatically return from a current BWP (that is, the initial BWP) to a default BWP (that is, a switched to BWP) based on an agreement reached with the network device in advance or a protocol definition after bwp-InactiveTimer expires, and then the terminal device determines a changed number of repetitions (that is, the second number of repetitions) based on the BWP difference.

It should be noted that if the BWP difference is equal to 0, that is, if the changed BWP is equal to the initial BWP, the terminal device may keep the number of repetitions for the PUCCH unchanged, that is, keep the number of repetitions for the PUCCH as the first number of repetitions. The reason is that if the BWP does not change, the frequency hopping gain is unchanged. Therefore, the number of repetitions for the PUCCH may remain unchanged.

In an implementation method 2, the indication information is a first field in third DCI, a first part of bits in the first field indicate an MCS, and a second part of bits in the first field indicate the second number of repetitions.

The third DCI may be DCI format 0_1, DCI format 1_0, DCI format 1_1, DCI format 1_2, or the like.

For example, an MCS field in the third DCI includes five bits, and two most significant bits in the MCS field may be used to indicate four numbers of repetitions for the PUCCH, which are respectively 1, 2, 4, and 8. For example, when the two most significant bits are 00, it is indicated that the number of repetitions is 1. When the two most significant bits are 01, it is indicated that the number of repetitions is 2. When the two most significant bits are 10, it is indicated that the number of repetitions is 4. When the two most significant bits are 11, it is indicated that the number of repetitions is 8. Therefore, if the two most significant bits in the MCS field are 00, the terminal device determines that the changed number of repetitions (that is, the second number of repetitions) for the PUCCH is 1. For other similar cases, examples are not listed again. In the method, a field in DCI that is used to schedule the PDSCH is re-interpreted (re-interpretation), to indicate a needed number of repetitions for sending the PUCCH when an acknowledgment/negative acknowledgment (ACK/NACK) message is fed back for the PDSCH.

Certainly, a type of the field that is re-interpreted is not limited in this embodiment of this application. In another example, a HARQ process number (HARQ process number) field or a PDSCH-to-HARQ_feedback timing indicator field in the third DCI may be re-interpreted. For example, two most significant bits in the field are used to indicate four numbers of repetitions. Alternatively, in another example, when a HARQ process corresponding to the HARQ process number field stops, all bits in the HARQ process may be used to indicate a plurality of numbers of repetitions. For example, when the HARQ process number field includes 5 bits, 32 numbers of repetitions may be indicated.

Similarly, any one of the following fields in the third DCI may also be re-interpreted to indicate the second number of repetitions: a Frequency domain resource assignment field, a Random Access Preamble index field, a PRACH Mask index field, a Reserved bits field, a Time domain resource assignment field, a Redundancy version field, a Downlink assignment index field, a TPC command for scheduled PUCCH field, and a Carrier indicator field.

In another implementation method, the second part of bits in the first field in the third DCI may not indicate the second number of repetitions, but indicate a change amount of the number of repetitions. In this case, the terminal device may determine the second number of repetitions based on the first number of repetitions and the change amount of the number of repetitions.

In an implementation method 3, the indication information is a second field in fourth DCI, and the second field indicates the PUCCH and indicates the second number of repetitions.

The fourth DCI may be DCI format 0_1, DCI format 1_0, DCI format 1_1, DCI format 1_2, or the like.

In addition to maintaining an existing meaning, the second field in the fourth DCI further indicates the second number of repetitions.

A PRI field in the fourth DCI is used as an example. The PRI field includes three bits. The three bits maintain an existing meaning, that is, the three bits indicate a PUCCH resource (which is alternatively understood as indicating a PUCCH), and further indicate the second number of repetitions.

For example, the second number of repetitions that is indicated by the PRI field is defined as follows:

If PRI=000 to 001, it is indicated that the number of repetitions for the PUCCH is 1.

If PRI=010 to 011, it is indicated that the number of repetitions for the PUCCH is 2.

If PRI=100 to 101, it is indicated that the number of repetitions for the PUCCH is 4.

If PRI=110 to 111, it is indicated that the number of repetitions for the PUCCH is 8.

Similarly, any of the following fields in the fourth DCI may further indicate the second number of repetitions in addition to maintaining an existing meaning: a Bandwidth part indicator field, a HARQ process number field, a PDSCH-to-HARQ_feedback timing indicator field, a Frequency domain resource assignment field, a Random Access Preamble index field, a PRACH Mask index field, a Reserved bits field, a Time domain resource assignment field, a Redundancy version field, a Downlink assignment index field, a TPC command for scheduled PUCCH field, and a Carrier indicator field.

In another implementation method, the second field in the fourth DCI may not indicate the second number of repetitions, but indicates a change amount of the number of repetitions. In this case, the terminal device may determine the second number of repetitions based on the first number of repetitions and the change amount of the number of repetitions.

In an implementation method 4, the indication information includes M bits in a third field in fifth DCI and N bits in a fourth field in the fifth DCI, the M bits and the N bits jointly indicate the second number of repetitions, and both M and N are positive integers.

The fifth DCI may be DCI format 0_1, DCI format 1_0, DCI format 1_1, DCI format 1_2, or the like.

In the method, the two fields in the fifth DCI jointly indicate the second number of repetitions. For example, one bit in an MCS field and one bit in a PRI field in the DCI jointly indicate four numbers of repetitions. Certainly, the second number of repetitions may alternatively be jointly indicated by three or more fields. The method is flexible, and a field in the DCI is slightly affected.

For example, any two or more of the following fields in the fifth DCI may jointly indicate the second number of repetitions: a Bandwidth part indicator field, a HARQ process number field, a PDSCH-to-HARQ_feedback timing indicator field, a Frequency domain resource assignment field, a Random Access Preamble index field, a PRACH Mask index field, a Reserved bits field, a Time domain resource assignment field, a Redundancy version field, a Downlink assignment index field, a TPC command for scheduled PUCCH field, and a Carrier indicator field.

In another implementation method, the third field in the fourth DCI and the fourth field in the fifth DCI may not jointly indicate the second number of repetitions, but jointly indicate a change amount of the number of repetitions. In this case, the terminal device may determine the second number of repetitions based on the first number of repetitions and the change amount of the number of repetitions.

In an implementation method, before the network device configures a terminal device–level dedicated PUCCH resource for the terminal device, the terminal device sends uplink information based on the first number of repetitions or the second number of repetitions and by repeatedly using a common PUCCH. The reason is that if the network device has configured the terminal device–level dedicated PUCCH resource for the terminal device, the dedicated PUCCH resource can be generally repeatedly used, that is, the uplink information can be repeatedly sent on the dedicated PUCCH resource. Therefore, the terminal device may not use the common PUCCH to repeatedly send the uplink information.

It may be understood that, to implement the functions in the foregoing embodiments, the terminal device or the network device includes corresponding hardware structures and/or software modules for performing the functions. A person skilled in the art should be readily aware that, with reference to the units and method steps in the examples described in embodiments disclosed, this application can be implemented by hardware or a combination of hardware and computer software. Whether a function is performed by hardware or hardware driven by computer software depends on a particular application scenario and a design constraint condition of the technical solutions.

FIG. 3 and FIG. 4 are diagrams of structures of possible communication apparatuses according to embodiments of this application. These communication apparatuses may be configured to implement functions of the terminal device or the network device in the foregoing method embodiments, and therefore can also achieve beneficial effects of the foregoing method embodiments. In embodiments of this application, the communication apparatus may be the terminal device or the network device, or may be a module (for example, a chip) used in the terminal device or the network device.

A communication apparatus 300 shown in FIG. 3 includes a processing unit 310 and a transceiver unit 320. The communication apparatus 300 is configured to implement functions of the terminal device or the network device in the foregoing method embodiments.

When the communication apparatus 300 is configured to implement a function of the terminal device in the foregoing method embodiments, the transceiver unit 320 is configured to receive first DCI, and the processing unit 310 is configured to determine a first number of repetitions for a PUCCH based on the first DCI. The transceiver unit 320 is further configured to receive indication information, and the processing unit 310 is further configured to determine a second number of repetitions for the PUCCH based on the indication information, where the second number of repetitions is different from the first number of repetitions.

In a possible implementation method, the processing unit 310 is further configured to receive a message 4 MSG4 based on the first DCI and by using the transceiver unit 320, where the PUCCH carries response information corresponding to the MSG4.

In a possible implementation method, the indication information includes information about a changed BWP. That the processing unit 310 is configured to determine the second number of repetitions for the PUCCH based on the indication information specifically includes: The processing unit 310 is configured to: determine a difference between the changed BWP and an initial BWP based on the information about the changed BWP; determine a change amount of a number of repetitions based on the difference; and determine the second number of repetitions based on the change amount of the number of repetitions and the first number of repetitions.

In a possible implementation method, that the processing unit 310 is configured to determine the change amount of the number of repetitions based on the difference specifically includes: The processing unit is configured to determine the change amount of the number of repetitions based on the difference between the changed BWP and the initial BWP and a step of the number of repetitions.

In a possible implementation method, the step of the number of repetitions is predefined. Alternatively, the transceiver unit 320 is further configured to receive system information, where the system information includes the step of the number of repetitions.

In a possible implementation method, when the difference is greater than 0, the second number of repetitions is less than the first number of repetitions. Alternatively, when the difference is less than 0, the second number of repetitions is greater than the first number of repetitions.

In a possible implementation method, the indication information includes a changed BWP. That the processing unit 310 is configured to determine the second number of repetitions for the PUCCH based on the indication information specifically includes: The processing unit 310 is configured to determine the second number of repetitions corresponding to the changed BWP.

In a possible implementation method, the indication information is any one of the following: second DCI, RRC signaling, or a MAC CE.

In a possible implementation method, the indication information is a first field in third DCI, a first part of bits in the first field indicate an MCS, and a second part of bits in the first field indicate the second number of repetitions.

In a possible implementation method, the indication information is a second field in fourth DCI, and the second field indicates the PUCCH and indicates the second number of repetitions.

In a possible implementation method, the indication information includes M bits in a third field in fifth DCI and N bits in a fourth field in the fifth DCI, the M bits and the N bits jointly indicate the second number of repetitions, and both M and N are positive integers.

In a possible implementation method, the transceiver unit 320 is further configured to send capability information before receiving the indication information, where the capability information indicates that the terminal device supports dynamic adjustment of the number of repetitions.

When the communication apparatus 300 is configured to implement a function of the network device in the foregoing method embodiments, the processing unit 310 is configured to: control the transceiver unit 320 to send first DCI, where the first DCI is used to determine a first number of repetitions for a PUCCH; and send indication information, where the indication information is used to determine a second number of repetitions for the PUCCH, and the second number of repetitions is different from the first number of repetitions.

In a possible implementation method, the first DCI is further used to receive an MSG4, and the PUCCH carries response information corresponding to the MSG4.

In a possible implementation method, the indication information includes information about a changed BWP, and the information about the changed BWP is used to determine the second number of repetitions.

In a possible implementation method, that the information about the changed BWP is used to determine the second number of repetitions includes: The information about the changed BWP and a step of a number of repetitions are used to determine the second number of repetitions.

In a possible implementation method, the step of the number of repetitions is predefined. Alternatively, the method further includes: sending system information, where the system information includes the step of the number of repetitions.

In a possible implementation method, when the difference is greater than 0, the second number of repetitions is less than the first number of repetitions. Alternatively, when the difference is less than 0, the second number of repetitions is greater than the first number of repetitions.

In a possible implementation method, the indication information is any one of the following: second DCI, RRC signaling, or a MAC CE.

In a possible implementation method, the indication information is a first field in third DCI, a first part of bits in the first field indicate an MCS, and a second part of bits in the first field indicate the second number of repetitions.

In a possible implementation method, the indication information is a second field in fourth DCI, and the second field indicates the PUCCH and indicates the second number of repetitions.

In a possible implementation method, the indication information includes M bits in a third field in fifth DCI and N bits in a fourth field in the fifth DCI, the M bits and the N bits jointly indicate the second number of repetitions, and both M and N are positive integers.

In a possible implementation method, the processing unit 310 is further configured to control the transceiver unit 320 to receive capability information before sending the indication information, where the capability information indicates that the terminal device supports dynamic adjustment of a number of repetitions.

For more detailed descriptions of the processing unit 310 and the transceiver unit 320, directly refer to related descriptions in the foregoing method embodiments. Details are not described herein again.

A communication apparatus 400 shown in FIG. 4 includes a processor 410 and an interface circuit 420. The processor 410 and the interface circuit 420 are coupled to each other. It may be understood that the interface circuit 420 may be a transceiver or an input/output interface. Optionally, the communication apparatus 400 may further include a memory 430, configured to store instructions executed by the processor 410, store input data needed by the processor 410 to run the instructions, or store data generated after the processor 410 runs the instructions.

When the communication apparatus 400 is configured to implement the foregoing method embodiments, the processor 410 is configured to implement a function of the processing unit 310, and the interface circuit 420 is configured to implement a function of the transceiver unit 320.

It may be understood that the processor in embodiments of this application may be a central processing unit (Central Processing Unit, CPU), or may be another general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The general-purpose processor may be a microprocessor or any regular processor.

The method steps in embodiments of this application may be implemented by hardware, or may be implemented by executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a compact disc read-only memory (compact disc read-only memory, CD-ROM), or a storage medium in any other form well known in the art. For example, a storage medium is coupled to the processor, so that the processor can read information from the storage medium and write information into the storage medium. Certainly, the storage medium may alternatively be a component of the processor. The processor and the storage medium may be located in an ASIC. In addition, the ASIC may be located in a terminal device or a network device. Certainly, the processor and the storage medium may alternatively exist in an access network device or a terminal as discrete components.

All or some of the foregoing embodiments may be implemented by using software, hardware, firmware, or any combination thereof. When software is used for implementation, all or some of embodiments may be implemented in a form of a computer program product. The computer program product includes one or more computer programs or instructions. The computer program (English: Computer Program) refers to a group of instructions that indicate each step of an electronic computer or another device having a message processing capability, and is usually written in a programming language and is run on a target architecture. When the computer programs or instructions are loaded and executed on a computer, all or some of the procedures or functions according to embodiments of this application are performed. The computer may be a general-purpose computer, a dedicated computer, a computer network, or another programmable apparatus. The computer programs or the instructions may be stored in a computer-readable storage medium, or may be transmitted from a computer-readable storage medium to another computer-readable storage medium. For example, the computer programs or the instructions may be transmitted from a website, computer, server, or data center to another website, computer, server, or data center in a wired or wireless manner. The computer-readable storage medium may be any usable medium accessible by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In various embodiments of this application, unless otherwise specified or logically conflicted, terms and/or descriptions in different embodiments are consistent and may be mutually referenced, and technical features in different embodiments may be combined based on an internal logical relationship thereof, to form a new embodiment.

In this application, "at least one" means one or more, and "a plurality of" means two or more. "And/or" describes an association relationship between associated objects, and indicates that three relationships may exist. For example, A and/or B may indicate the following cases: Only A exists, both A and B exist, and only B exists, where A and B may be singular or plural. In the text descriptions of this application, the character "/" generally indicates an "or" relationship between the associated objects. In the formula in this application, the character "/" indicates a "division" relationship between the associated objects.

It may be understood that various numbers in embodiments of this application are merely used for distinguishing for ease of description, and are not used to limit the scope of embodiments of this application. Sequence numbers of the foregoing processes do not m an execution sequence, and the execution sequence of the processes should be determined based on functions and internal logic of the processes.

1. A communication method, comprising:
receiving first downlink control information DCI;
determining a first number of repetitions for a physical uplink control channel PUCCH based on the first DCI;
receiving indication information; and
determining a second number of repetitions for the PUCCH based on the indication information.

2. The method according to claim 1, wherein the method further comprises:
receiving a message 4 MSG4 based on the first DCI, wherein the PUCCH carries response information corresponding to the MSG4.

3. The method according to claim 1, wherein the indication information comprises information about a changed bandwidth part BWP, wherein
the determining the second number of repetitions for the PUCCH based on the indication information comprises:
determining a difference between the changed BWP and an initial BWP based on the information about the changed BWP;
determining a change amount of a number of repetitions based on the difference; and
determining the second number of repetitions based on the change amount of the number of repetitions and the first number of repetitions.

4. The method according to claim 3, wherein the determining the change amount of the number of repetitions based on the difference comprises:
determining the change amount of the number of repetitions based on the difference between the changed BWP and the initial BWP and a step of the number of repetitions;
wherein the step of the number of repetitions is predefined; or
the method further comprises: receiving system information, wherein the system information comprises the step of the number of repetitions.

5. The method according to claim 1, wherein the indication information is any one of the following: second DCI, radio resource control RRC signaling, or a medium access control element MAC CE.

6. The method according to claim 1, wherein the indication information is a first field in third DCI, a first part of bits in the first field indicate a modulation and coding scheme MCS, and a second part of bits in the first field indicate the second number of repetitions.

7. The method according to claim 1, wherein before the receiving the indication information, the method further comprises:
sending capability information, wherein the capability information indicates that a terminal device supports dynamic adjustment of the number of repetitions.

8. A communication apparatus, comprising:
at least one processor; and
one or more memories coupled to the at least one processor and storing programming instructions for execution by the at least one processor to:
receive first downlink control information DCI;
determine a first number of repetitions for a physical uplink control channel PUCCH based on the first DCI;
receive indication information; and
determine a second number of repetitions for the PUCCH based on the indication information.

9. The apparatus according to claim 8, wherein the one or more memories further storing programming instructions for execution by the at least one processor to:
receive a message 4 MSG4 based on the first DCI, wherein the PUCCH carries response information corresponding to the MSG4.

10. The apparatus according to claim 8, wherein the indication information comprises information about a changed bandwidth part BWP, wherein
the determine the second number of repetitions for the PUCCH based on the indication information comprises:
determine a difference between the changed BWP and an initial BWP based on the information about the changed BWP;
determine a change amount of a number of repetitions based on the difference; and
determine the second number of repetitions based on the change amount of the number of repetitions and the first number of repetitions.

11. The apparatus according to claim 10, wherein the determine the change amount of the number of repetitions based on the difference comprises:
determine the change amount of the number of repetitions based on the difference between the changed BWP and the initial BWP and a step of the number of repetitions;
wherein the step of the number of repetitions is predefined; or
the one or more memories further storing programming instructions for execution by the at least one processor to: receive system information, wherein the system information comprises the step of the number of repetitions.

12. The apparatus according to claim claim 10, wherein the indication information is any one of the following: second DCI, radio resource control RRC signaling, or a medium access control element MAC CE.

13. The apparatus according to claim 8, wherein the indication information is a first field in third DCI, a first part of bits in the first field indicate a modulation and coding scheme MCS, and a second part of bits in the first field indicate the second number of repetitions.

14. The apparatus according to claim 8, wherein the one or more memories further storing programming instructions for execution by the at least one processor to:
send capability information, wherein the capability information indicates that a terminal device supports dynamic adjustment of the number of repetitions.

15. A communication apparatus, comprising:
at least one processor; and
one or more memories coupled to the at least one processor and storing programming instructions for execution by the at least one processor to:
send first downlink control information DCI, wherein the first DCI is used to determine a first number of repetitions for a physical uplink control channel PUCCH; and
send indication information, wherein the indication information is used to determine a second number of repetitions for the PUCCH, and the second number of repetitions is different from the first number of repetitions.

16. The apparatus according to claim 15, wherein the first DCI is further used to receive a message 4 MSG4, and the PUCCH carries response information corresponding to the MSG4.

17. The apparatus according to claim 16, wherein the indication information comprises information about a changed bandwidth part BWP, and the information about the changed BWP is used to determine the second number of repetitions;
wherein that the information about the changed BWP is used to determine the second number of repetitions comprises:
the information about the changed BWP and a step of a number of repetitions are used to determine the second number of repetitions;
wherein the step of the number of repetitions is predefined; or
the one or more memories further storing programming instructions for execution by the at least one processor to: send system information, wherein the system information comprises the step of the number of repetitions.

18. The apparatus according to claim 15, wherein the indication information is second DCI, radio resource control RRC signaling, or a medium access control element MAC CE.

19. The apparatus according to claim 15, wherein the indication information is a first field in third DCI, a first part of bits in the first field indicate a modulation and coding scheme MCS, and a second part of bits in the first field indicate the second number of repetitions.

20. The apparatus according to claim 15, wherein the one or more memories further storing programming instructions for execution by the at least one processor to:
receive capability information, wherein the capability information indicates that a terminal device supports dynamic adjustment of the number of repetitions.
